(19) United States
(12) Patent Application Publication
(10) Pub. No.: US 2023/0053989 A1
(43) Pub. Date: Feb. 23, 2023

(54) FLUID CONTAINER COMPRISING A SHUT-OFF DEVICE

(71) Applicant: Continental Automotive Technologies GmbH, Hannover (DE)

(72) Inventors: Vit Nahlovsky, Jicin (CZ); Ales Jakubec, Dolni Bousov (CZ); Stephan Schlicht, Nauheim (DE)

(73) Assignee: Continental Automotive Technologies GmbH, Hannover (DE)

(21) Appl. No.: 17/904,373

(22) PCT Filed: Dec. 9, 2020
(86) PCT No.: PCT/EP2020/085182

§ 371 Date: Aug. 16, 2022

(30) Foreign Application Priority Data
Feb. 18, 2020 (DE) 10 2020 202 035.3

(51) Int. Cl. B60T 11/26; F16K 15/06; B60T 11/28; B60T 11/22; F15B 1/26; F15B 20/00

(52) U.S. Cl. CPC B60T 11/26; F16K 15/065; B60T 11/28; B60T 11/22; F15B 1/26; F15B 20/00

(57) ABSTRACT

A fluid container for a hydraulic unit comprises a container housing which has at least one connection part, which can be shut off by means of a shut-off device arranged in the fluid container. The container housing has at least one internal chamber and a channel for connecting the internal chamber to the hydraulic unit. The connection part and the shut-off device are combined in a separate module, which is connected to the container housing.

### CROSS-REFERENCE TO RELATED APPLICATIONS

The present application is a National Stage Application under 35 U.S.C. § 371 of International Patent Application No. PCT/EP2020/085182 filed on Dec. 9, 2020, and claims priority from German Patent Application No. 10 2020 202 035.3 filed on Feb. 18, 2020, in the German Patent and Trademark Office, the disclosures of which are herein incorporated by reference in their entireties.

### TECHNICAL FIELD

The invention related to fluid containers for hydraulic units for vehicle brake systems.

### BACKGROUND

Fluid containers for hydraulic units are known in many forms, for example as brake fluid containers for supplying brake devices for hydraulic motor vehicle brake systems. The hydraulic connection to the respective unit is usually effected by connection parts which are integrally formed on the outside of the container housing and which are received in a sealing manner in corresponding receiving seats in the hydraulic unit.

When a strong force is exerted on the fluid container, for example as a result of an accident, it may happen that the connection parts are driven out of their receiving seats. In order to prevent the stored fluid from escaping in such a case, there is a known practice of providing separate shut-off devices which automatically shut off the hydraulic connection by means of the connection parts outside the receiving seats.

DE 39 12 110 A1, for example, discloses shut-off devices which, during the production of the fluid container, have to be mounted in the interior of the container housing.

Complexity in production, construction and assembly, a large space requirement for assembly tools and tool inserts and the need for additional structural elements for mounting and fixing the shut-off device within the container housing are considered to be disadvantageous in such solutions. For functional testing of the shut-off device, there is a need to handle large-volume components, which may also have to be scrapped entirely in the event of a fault.

DE 10 2014 213 709 A1 discloses another shut-off device, which is implemented in the form of a cartridge that can be inserted from the outside into the connection part of a finished container. However, such a solution places an additional limitation on the diameter of the internal channel in the connection part and reduces the flow cross section, and can thus preferably be used for larger diameters.

Fluid containers of the type in question are usually constructed as shell bodies consisting of two half-shells welded to one another in a pressure-tight manner. The two half-shells are generally produced in an injection molding process. To keep injection molding tools simple and advantageous and to avoid tool inserts and shorten cycle times, it is therefore desirable in principle to adapt all the molded-on parts to the demolding direction, for example to design connection parts to be directed in the demolding direction. Even minor adaptations to various installation positions and installation space conditions at the installation site can lead to completely redesigned container housings and injection molds.

Therefore, a fluid container having a shut-off device which can adapted flexibly to different installation configurations, and where the shut-off devices could also be used with comparatively narrow connection parts and their assembly and functional testing could be carried out more easily is thus far unkown.

### SUMMARY

One general aspect includes a fluid container for a hydraulic unit. The fluid container also includes a container housing having at least one internal chamber. The container also includes at least one connection part, which projects relative to an outer side of the fluid container. The container also includes an internal channel for connecting the internal chamber to the unit and a receiving seat of the unit to receive the connection part. The container also includes a shut-off device for shutting off the internal channel when the connection part is outside the receiving seat. The connection part and the shut-off device are combined in a separate module, which is connected to the container housing.

A brake device for a hydraulic motor vehicle brake system may include at least one fluid container. The fluid container also includes a container housing having at least one internal chamber. The container also includes at least one connection part, which projects relative to an outer side of the fluid container. The container also includes an internal channel for connecting the internal chamber to the unit and a receiving seat of the unit to receive the connection part. The container also includes a shut-off device for shutting off the internal channel when the connection part is outside the receiving seat. The connection part and the shut-off device are combined in a separate module, which is connected to the container housing.

### BRIEF DESCRIPTION OF THE DRAWINGS

Further embodiments, details, features, advantages and possible applications can be found in subclaims and in the following figures and corresponding descriptions of figures. In the drawings:

FIG. 1 shows a simplified illustration of one embodiment of the fluid container within a brake device for a hydraulic motor vehicle brake system in cross section.

FIG. 2 shows a three-dimensional illustration of another embodiment of the fluid container.

FIG. 3 shows the module according to the embodiment in FIG. 1 in an assembled view (a) and in an exploded view (b).

FIG. 4 shows an enlarged sectional view of one embodiment of the connection part with the shut-off device mounted.

FIG. 5 shows three-dimensional views of a base body of the module according to FIG. 3.

### DETAILED DESCRIPTION

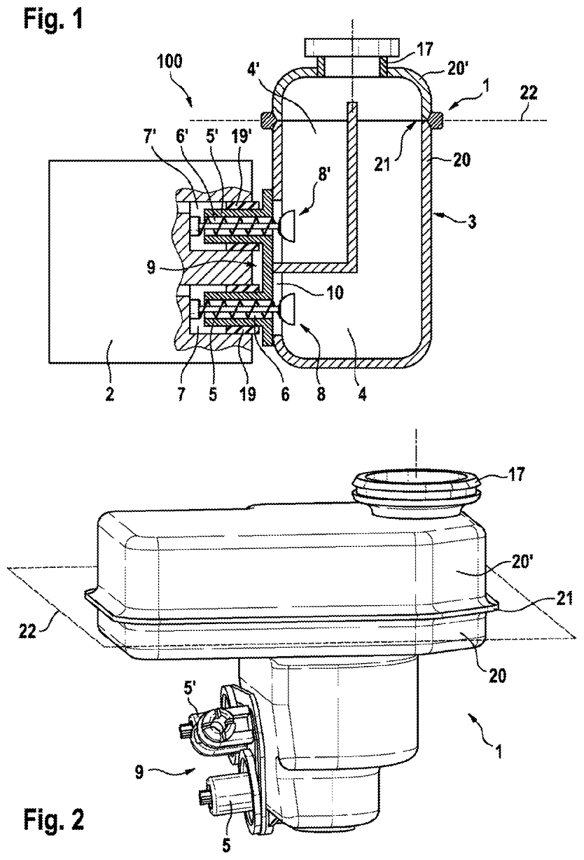

FIG. 1 shows, a brake device 100 for a hydraulic motor vehicle brake system, having a hydraulic unit 2 for generating and/or modulating a brake pressure and a fluid container 1 mounted on the unit 2.

The fluid container 1 has a container housing 3, the interior of which, in the embodiment shown, is subdivided into two internal chambers 4, 4′, which can be filled with a brake fluid.

A filler neck 17, which can be closed with a closure cap, is provided for filling the fluid container 1.

The hydraulic connection between the unit 2 and the internal chambers 4, 4 is made through internal channels 6, 6′ within two connection parts 5, 5′ aligned parallel to one another and arranged on the outside of the fluid container 1.

The two connection parts 5, 5′ are received in corresponding receiving seats 7, 7′ in the unit 2 and are sealed off from the outside therein by means of sealing elements 19, 19′.

Two shut-off devices 8, 8′ are used for forcibly shutting off the internal channels 5, 5′ when the connection parts 5, 5′ are outside the receiving seats 6, 6′. With regard to the shut-off device 8, reference is made to FIG. 4.

The fluid container 1 is constructed as a shell body with a lower and an upper half-shell 20, 20′. In the embodiment shown, the two half-shells 20, 20′ are produced in an injection molding process and then welded in a hydraulically tight and service-pressure-resistant manner at an encircling joining seam 21. Here, as in most applications, the joining seam 21 runs in what is referred to as a parting plane 22. The parting plane 22 may be aligned orthogonally to the axis of the filler neck 17, which is designed as an integral component of the upper half-shell 20′.

In the exemplary embodiment illustrated, the two connection parts 5, 5′ are aligned orthogonally to the filler neck 17 or parallel to the parting plane 22 and thus transversely to the demolding direction of the lower half-shell 20. Such a configuration would not be possible without a comparatively complex injection molding tool with separate tool inserts in the case of connection parts 5, 5′ formed integrally with the half-shell 20.

In order to avoid this, the connection parts 5, 5′ are combined together with the corresponding shut-off devices 8, 8′ in a separate module 9.

For this purpose, the container housing 3 has, in an outer wall, an aperture 10, is closed off from the outside in a service-pressure-tight manner by the module 9.

The connection between the module 9 and the container housing 3 may be implemented in permanently sealed manner by material bonding, in particular by welding. Other types of connection, such as adhesive bonding, screwing, latching, clipping, etc., are, of course, likewise permissible.

The module 9 can be constructed, functionally tested, stored and transported as a separately handleable assembly without the need for the large-volume container housing 3 to be handled at the same time.

FIG. 2 shows another embodiment of the fluid container 1.

In contrast to the exemplary embodiment described above, the alignment of the two connection parts 5, 5 is slightly inclined with respect to the orthogonal to the axis of the filler neck 17 or with respect to the parting plane 22. Thus, the connection parts 5, 5 are aligned substantially transversely to the axis of the filler neck 17 but not exactly orthogonally thereto. This may be necessary, for example, in order to adapt the plug-in direction to the slight inclination of the bulkhead in the vehicle on which the unit 2 is mounted.

The module 9 can be effectively used as a pre-prepared and functionally tested standard component which is attached to variants of the container housing 3 of different designs and shapes. The respective variants of the container housing 3 or individual half-shells 20, 21 can be produced in injection molding tools of simple construction and can thus be adapted at comparatively low cost to different installation conditions—for example different orientations of the connection parts 5, 5′, external shapes, internal structure, volumes and the like.

Likewise, a number of variants of the module 9 can be provided, e.g. with differently spaced, positioned and dimensioned connection parts 5, 5′ and/or shut-off devices 8, 8′. Thus, the fluid container 1 could be adapted efficiently to different hydraulic units 2 with, for example, differently designed interfaces or fluid flow rates by attaching a suitable variant of the module 9 to the same container housing 3.

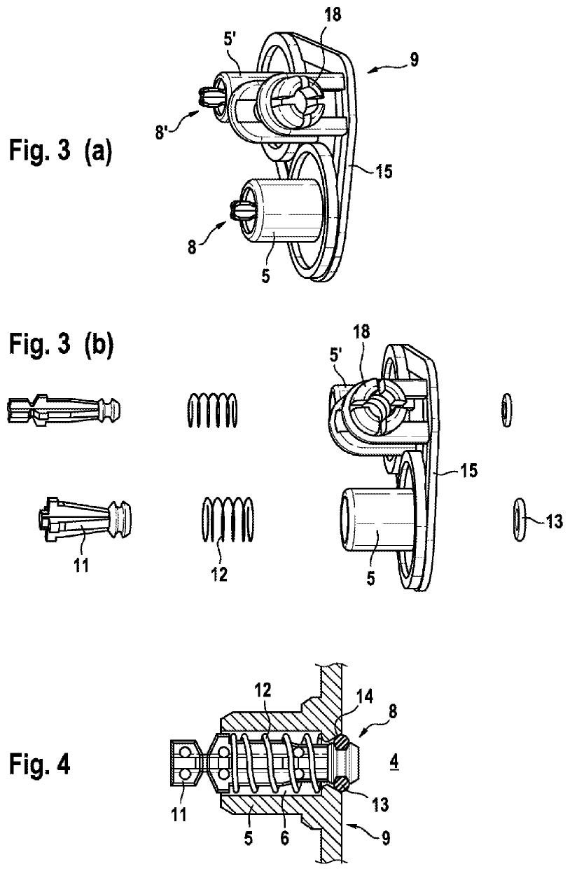

FIG. 3 shows the exemplary embodiment of the module 9 according to FIG. 2 in an assembled view and in an exploded view. In the embodiment shown here, the module 9 has a base body 15 which is produced from plastic by injection molding. The two connection parts 5, 5′ are formed in one piece with the base body 15.

The shut-off devices 8 are arranged substantially completely within the connection parts 5. For the installation of shut-off devices 8, a spring 12 and a pin-shaped valve body 11 are pushed from the outside into the connection part 5, with the result that the end of the valve body 11 adjacent to the internal chamber projects inward out of the connection part 5. A sealing body 13 is attached to this end and serves at the same time to secure the valve body 11 in the connection part 5 in the closed state.

FIG. 4 shows a an embodiment of the shut-off device 8 in the closed state in cross section.

The shut-off device 8 is arranged and fastened in a substantially space-saving manner in the internal channel 6 of the connection part 5. It has a spring-loaded valve body 11 with a sealing body 13 provided thereon at the end adjacent to the internal chamber. In a closed state shown here, the sealing body rests on a valve seat 14 formed in the mouth region of the internal channel 6 and thereby blocks the internal channel 6. In the embodiment shown, the length of the valve body 11 is designed in such a way that, in the closed state, the valve body projects outward from the connection part 5. As the connection part 5 is inserted into the receiving seat 7, the valve body 11 is supported on the bottom of the receiving seat 7 and is thereby forced to move in the direction of the internal chamber 4. During this process, the sealing body 13 rises from the valve seat 14 and thereby unblocks the internal channel 6.

The valve body 11 may also be of shortened design, with the result that it is completely within the internal channel 6 in the closed state. In such an embodiment, there is a need within the receiving seat 7 for a separate support means which, as the connection part is inserted into the receiving seat 7, engages axially in the channel 6 and moves the valve body 11 in the direction of the internal chamber 4.

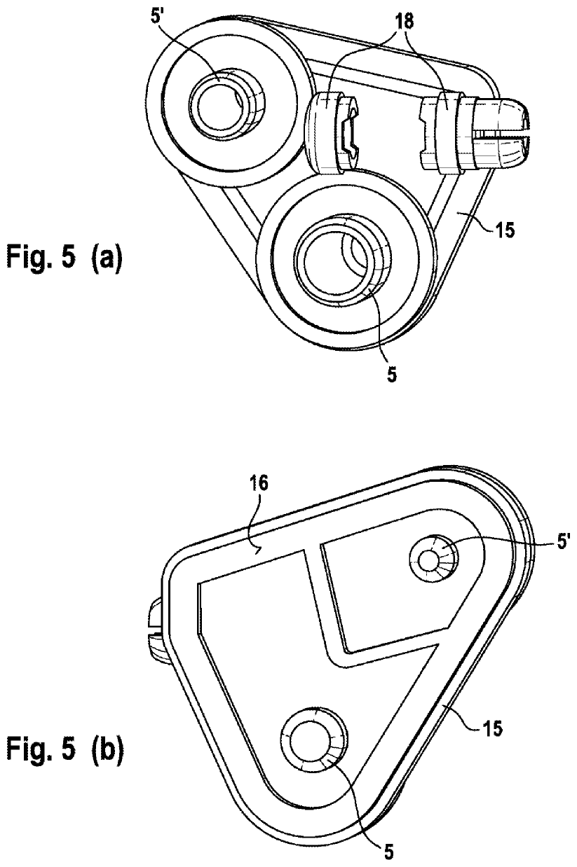

FIG. 5 shows the base body 15 of the module 9 according to FIGS. 2 and 3. The module 9 provides a location for placing separate fastening means 18, which are provided for fixing the fluid container 1 on the unit 2. In this way, adaptations to different fixing interfaces can be implemented without the need to modify the container housing 3 for this purpose.

In the exemplary embodiment shown, the fastening means 18 is implemented as a pair of eyelets which are formed in one piece with the base body 15 and are provided for the insertion of a transverse pin (not shown here). For latching the transverse pin, one of the eyelets has special spring tabs, which serve to secure a thickened end of the transverse pin.

The above-described embodiment of the module 9 is provided for welding to the container housing 3. For an optimum pressure-tight weld seam, a specially delimited connecting surface 16 is provided on the base body 15. Depending on the type of connection selected, the connecting surface 16 can be adapted accordingly to requirements. For example, this region of the base body can be designed with an increased material thickness and an adapted, for example roughened, surface. The remaining regions of the base body 15, on the other hand, can be optimized, for example, for low-cost production and low material consumption.

1. A fluid container for a hydraulic unit comprising:
a container housing having at least one internal chamber;
at least one connection part, which projects relative to an outer side of the fluid container;
an internal channel for connecting the internal chamber to the unit;
a receiving seat of the unit to receive the connection part;
a shut-off device for shutting off the internal channel when the connection part is outside the receiving seat; and
wherein the connection part and the shut-off device are combined in a separate module, which is connected to the container housing.

2. The fluid container as claimed in claim 1, wherein the container housing has, in an outer wall, an aperture which is closed by the module.

3. The fluid container as claimed in claim 1, wherein the module is arranged on the outside of the container housing.

4. The fluid container as claimed in claim 1, wherein the shut-off device further comprises a spring-loaded valve body which is arranged at least partly in the internal channel such that, as the connection part is received in the receiving seat, the valve body is supported in the receiving seat and forced in the direction of the internal chamber, thereby hydraulically unblocking the internal channel.

5. The fluid container as claimed in claim 1, wherein the module has, in addition to the connection part, at least one separate fastener for fixing the fluid container on the unit.

6. The fluid container as claimed in claim 1, wherein the fluid container has at least two half-shells, which are connected to one another in a parting plane, and the connection part is aligned parallel to the parting plane.

7. The fluid container as claimed in claim 1, wherein the fluid container has a filler neck and the connection part is aligned transversely in relation to the alignment of the filler neck.

8. The fluid container as claimed in claim 1, wherein the module has at least two connection parts aligned parallel to one another.

9. The fluid container as claimed in claim 1, wherein the connection between the module and the container housing is materially bonded.

10. The fluid container as claimed in claim 1, wherein the unit is a unit for generating and/or modulating a brake pressure in a hydraulic motor vehicle brake system.

11. A brake device for a hydraulic motor vehicle brake system comprising:
a fluid container;
a container housing having at least one internal chamber;
at least one connection part, which projects relative to an outer side of the fluid container;
an internal channel for connecting the internal chamber to the unit
a receiving seat of the unit to receive the connection part;
a shut-off device for shutting off the internal channel when the connection part is outside the receiving seat; and
wherein the connection part and the shut-off device are combined in a separate module, which is connected to the container housing.

12. The brake device as claimed in claim 11, wherein the container housing has an outer wall of the container housing defines an aperture, which is closed by the module.

13. The brake device as claimed in claim 11, wherein the module is arranged on the outside of the container housing.

14. The brake device as claimed in claim 11, wherein the shut-off device further comprises a spring-loaded valve body which is arranged at least partly in the internal channel such that, as the connection part is received in the receiving seat, the valve body is supported in the receiving seat and forced in the direction of the internal chamber, thereby hydraulically unblocking the internal channel.

15. The brake device as claimed in claim 11, wherein the module has at least one separate fastener for fixing the fluid container on the unit.

16. The brake device as claimed in claim 11, wherein the fluid container has at least two half-shells, connected to one another in a parting plane, and wherein the connection part is aligned parallel to the parting plane.

17. The brake device as claimed in claim 11, wherein the fluid container has a filler neck and the connection part is aligned transversely in relation to the filler neck.

18. The brake device as claimed in claim 11, wherein the module has at least two connection parts aligned parallel to one another.

19. The brake device as claimed in claim 11, wherein the connection between the module and the container housing is materially bonded.

20. The brake device as claimed in claim 11, wherein the hydraulic unit generates and/or modulates a brake pressure in the hydraulic motor vehicle brake system.
